(19) United States
(12) Patent Application Publication
(10) Pub. No.: US 2016/0275192 A1
(43) Pub. Date: Sep. 22, 2016

(54) PERSONALIZING AN E-BOOK SEARCH QUERY

(71) Applicant: Kobo Incorporated, Toronto (CA)

(72) Inventors: Yingbo MIAO, Toronto (CA); Nan HU, Toronto (CA); Jessica LEUNG, Toronto (CA); Inmar-Ella GIVONI, Toronto (CA)

(73) Assignee: Kobo Incorporated, Toronto (CA)

(21) Appl. No.: 14/660,609

(22) Filed: Mar. 17, 2015

(51) Int. Cl. G06F 17/30; G06Q 30/06; G06F 3/0483

(52) U.S. Cl. CPC G06F 17/30867; G06F 3/0483; G06F 17/30477; G06Q 30/0625; G06Q 30/0631

(57) ABSTRACT

Methods and systems for personalizing an e-Book search query are provided. The method receives an e-Book search query and searches an e-Book depository based on the query. A set of search results are obtained from the depository. In addition, personalized information about a user related to the query is also obtained. The personalized information is used to refine the set of search results into a set of user personalized e-Book search query results. The results are presented on a display of the e-reading device.

### TECHNICAL FIELD

Examples described herein relate to personalizing an e-Book search query.

### BACKGROUND

An electronic personal display is a mobile computing device that displays information to a user. While an electronic personal display may be capable of many of the functions of a personal computer, a user can typically interact directly with an electronic personal display without the use of a keyboard that is separate from, or coupled to, but distinct from the electronic personal display itself. Some examples of electronic personal displays include mobile digital devices/tablet computers and electronic readers (e-reading devices) such (e.g., Apple iPad®, Microsoft® Surface™, Samsung Galaxy Tab® and the like), handheld multimedia smartphones (e.g., Apple iPhone®, Samsung Galaxy S®, and the like), and handheld electronic readers (e.g., Amazon Kindle®, Barnes and Noble Nook®, Kobo Aura HD, Kobo Aura H2O, Kobo GLO and the like).

Some electronic personal display devices are purpose built devices designed to perform especially well at displaying digitally stored content for reading or viewing thereon. For example, a purpose build device may include a display that reduces glare, performs well in high lighting conditions, and/or mimics the look of text as presented via actual discrete pages of paper. While such purpose built devices may excel at displaying content for a user to read, they may also perform other functions, such as displaying images, emitting audio, recording audio, and web surfing, among others.

Electronic personal displays are among numerous kinds of consumer devices that can receive services and utilize resources across a network service. Such devices can operate applications or provide other functionality that links a device to a particular account of a specific service. For example, the electronic reader (e-reading device) devices typically link to an online bookstore, and media playback devices often include applications that enable the user to access an online median electronic library (or e-Library). In this context, the user accounts can enable the user to receive the full benefit and functionality of the device.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description of the drawings should not be understood as being drawn to scale unless specifically noted.

FIG. 1 illustrates a system utilizing applications and providing e-Book services on an e-reading device, according to an embodiment.

FIG. 2 illustrates an example architecture configuration of an e-reading device, according to an embodiment.

FIG. 3 illustrates a flowchart for personalizing an e-Book search query, according to an embodiment.

FIG. 4 illustrates a method for personalizing an e-Book search query, according to an embodiment.

### DETAILED DESCRIPTION

Methods and systems for personalizing an e-Book search query are disclosed. In one embodiment, an initial search takes all results that match the user's query and creates an ordering of the many items with a match according to what is the most relevant result. Such ordering can rely on, but is not limited to, on or more of a popularity of clicking on particular results, the level of match between the query and the document, how often results are purchased, how often a preview is viewed or downloaded, the popularity of the author, etc.

In one embodiment, the present technology personalizes a user's query results based on information particular to the user him/herself. For example, the personalization can include taking into account information about which books a user has already purchased, which books they have written a review on, or rated, which books purchased were actually read to completion, which books are likely interesting for them based on a personal recommendation system's output, and the like.

Unless specifically stated otherwise as apparent from the following discussions, it is appreciated that throughout the present Description of Embodiments, discussions utilizing terms such as “syncing,” “receiving”, “accessing”, “directing”, “storing”, “disabling”, “suspending”, or the like, often refer to the actions and processes of an electronic computing device/system, such as an electronic reader (“eReader”), electronic personal display, and/or a mobile (i.e., handheld) multimedia device, among others. The electronic computing device/system manipulates and transforms data represented as physical (electronic) quantities within the circuits, electronic registers, memories, logic, and/or components and the like of the electronic computing device/system into other data similarly represented as physical quantities within the electronic computing device/system or other electronic computing devices/systems.

In general, “e-Books” are a form of electronic publication content stored in digital format in a computer non-transitory memory, viewable on a computing device having display functionality. An e-Book can correspond to, or mimic, the paginated format of a printed publication for viewing, such as provided by printed literary works (e.g., novels) and periodicals (e.g., magazines, comic books, journals, etc.). Optionally, some e-Books may have chapter designations, as well as content that corresponds to graphics or images (e.g., such as in the case of magazines or comic books).

Multi-function devices, such as cellular-telephony or messaging devices, can utilize specialized applications (e.g., specialized e-reading application software) to view e-Books in a format that mimics the paginated printed publication. Still further, some devices (sometimes labeled as “e-reading devices”) can display digitally-stored content in a more reading-centric manner, while also providing, via a user input interface, the ability to manipulate that content for viewing, such as via discrete pages arranged sequentially (that is, pagination) corresponding to an intended or natural reading progression, or flow, of the content therein.

An “e-reading device”, variously referred to herein as an electronic personal display or mobile computing device, can refer to any computing device that can display or otherwise render an e-Book. By way of example, an e-reading device can include a mobile computing device on which an e-reading application can be executed to render content that includes e-Books (e.g., comic books, magazines, etc.). Such mobile computing devices can include, for example, a multi-functional computing device for cellular telephony/messaging (e.g., feature phone or smart phone), a tablet computer device, an ultra-mobile computing device, or a wearable computing device with a form factor of a wearable accessory device (e.g., smart watch or bracelet, glass-wear integrated with a computing device, etc.). As another example, an e-reading device can include an e-reading device, such as a purpose-built device that is optimized for an e-reading experience (e.g., with E-ink displays).

In one embodiment, reading statistics for a given user/reader are compiled and provide information to the reader such as e-reading session lengths, speed of reading, estimated time to complete remainder of e-book, e-books read, etc. Besides indicating reading progress (ex: You have completed 70% of the Pulitzer Prize shortlist for 2014), there will be a button to help users add remaining titles from the list to their library (“See which titles you're missing”), and enable them to buy title for download via a convenient e-commerce purchase transaction. In one embodiment, the system “learns” what types of books or kinds of books the user is most interested in based on the reading statistics associated with the user.

One or more embodiments described herein may be implemented through instructions that are executable by one or more processors. These instructions may be carried on a non-transitory computer-readable storage medium storing instructions that, when executed by a hardware processor of an e-reading device perform the instructions. Machines shown or described with figures below provide examples of processing resources and computer-readable mediums on which instructions for implementing embodiments described can be carried and/or executed. In particular, the numerous machines shown may include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer programs, or a computer usable carrier medium capable of carrying such a program.

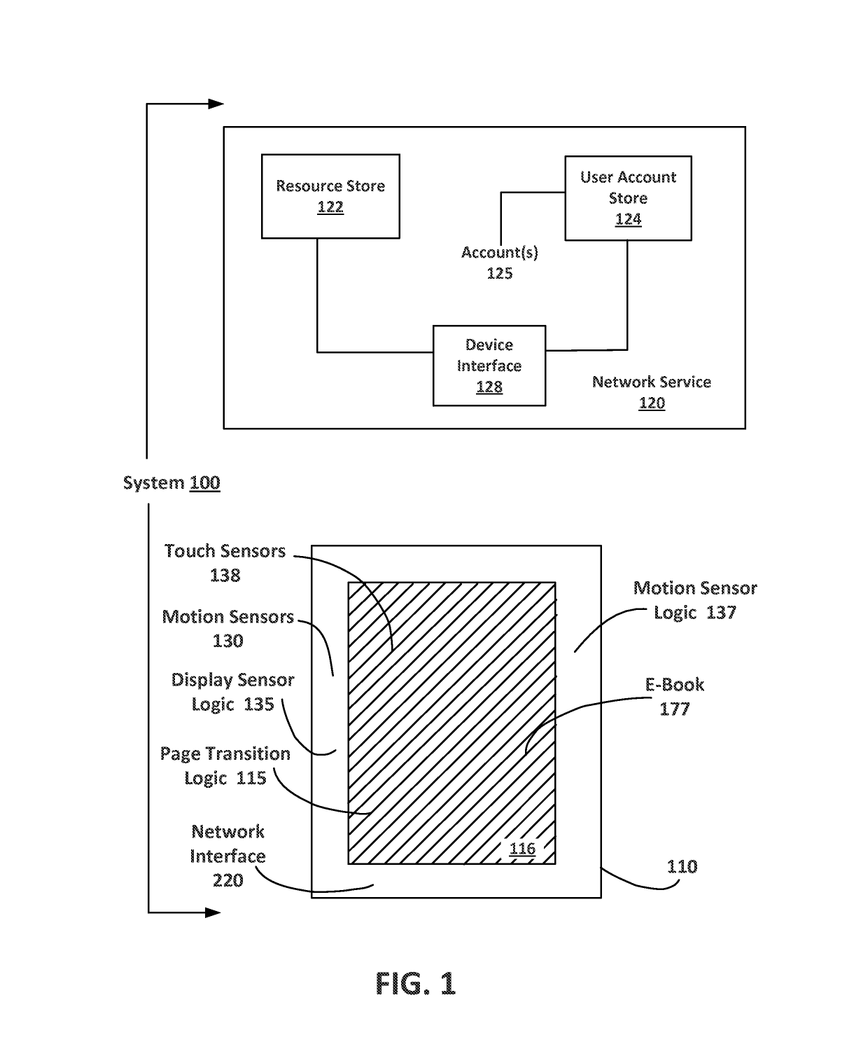

FIG. 1 illustrates a system 100 for utilizing applications and providing e-Book services on a computing device, according to an embodiment. In an example of FIG. 1, system 100 includes an electronic personal display device, shown by way of example as an e-reading device 110, and a network service 120. The network service 120 can include multiple servers and other computing resources that provide various services in connection with one or more applications that are installed on the e-reading device 110. By way of example, in one implementation, the network service 120 can provide e-Book services that communicate with the e-reading device 110. The e-Book services provided through network service 120 can, for example, include services in which e-Books are sold, shared, downloaded and/or stored. More generally, the network service 120 can provide various other content services, including content rendering services (e.g., streaming media) or other network-application environments or services.

The e-reading device 110 can correspond to any electronic personal display device on which applications and application resources (e.g., e-Books, media files, documents) can be rendered and consumed. For example, the e-reading device 110 can correspond to a tablet or telephony/messaging device (e.g., smart phone). In one implementation, for example, e-reading device 110 can run an e-reading device application that links the device to the network service 120 and enables e-Books provided through the service to be viewed and consumed. In another implementation, the e-reading device 110 can run a media playback or streaming application that receives files or streaming data from the network service 120. By way of example, the e-reading device 110 can be equipped with hardware and software to optimize certain application activities, such as reading electronic content (e.g., e-Books). For example, the e-reading device 110 can have a tablet-like form factor, although variations are possible. In some cases, the e-reading device 110 can also have an E-ink display.

In additional detail, the network service 120 can include a device interface 128, a resource store 122 and a user account store 124. The user account store 124 can associate the e-reading device 110 with a user and with an account 125. The account 125 can also be associated with one or more application resources (e.g., e-Books), which can be stored in the resource store 122. The device interface 128 can handle requests from the e-reading device 110, and further interface the requests of the device with services and functionality of the network service 120. The device interface 128 can utilize information provided with a user account 125 in order to enable services, such as purchasing downloads or determining what e-Books and content items are associated with the user device. Additionally, the device interface 128 can provide the e-reading device 110 with access to the resource store 122, which can include, for example, an online store. The device interface 128 can handle input to identify content items (e.g., e-Books), and further to link content items to the account 125 of the user.

Yet further, the user account store 124 can retain metadata for individual accounts 125 to identify resources that have been purchased or made available for consumption for a given account. The e-reading device 110 may be associated with the user account 125, and multiple devices may be associated with the same account. As described in greater detail below, the e-reading device 110 can store resources (e.g., e-Books) that are purchased or otherwise made available to the user of the e-reading device 110, as well as to archive e-Books and other digital content items that have been purchased for the user account 125, but are not stored on the particular computing device.

With reference to an example of FIG. 1, e-reading device 110 can include a display 116 and an optional housing, not shown. In an embodiment, the display 116 is touch-sensitive, to process touch inputs including gestures (e.g., swipes). For example, the display 116 may be integrated with one or more touch sensors 138 to provide a touch-sensing region on a surface of the display 116. For some embodiments, the one or more touch sensors 138 may include capacitive sensors that can sense or detect a human body's capacitance as input. In the example of FIG. 1, the touch sensing region coincides with a substantial surface area, if not all, of the display 116. Additionally, the housing can be integrated with touch sensors to provide one or more touch sensing regions, for example, on the bezel and/or back surface of the housing.

e-reading device 110 can also optionally include one or more motion sensors 130 arranged to detect motion imparted thereto, such as by a user while reading or in accessing associated functionality. In general, the motion sensor(s) 130 may be selected from one or more of a number of motion recognition sensors, such as but not limited to, an accelerometer, a magnetometer, a gyroscope and a camera. Further still, motion sensor 130 may incorporate or apply some combination of the latter motion recognition sensors.

e-reading device 110 further includes motion sensor logic 137 to interpret user input motions as commands based on detection of the input motions by motion sensor(s) 130. For example, input motions performed on e-reading device 110 such as a tilt, a shake, a rotation, a swivel or partial rotation and an inversion may be detected via motion sensors 130 and interpreted as respective commands by motion sensor logic 137.

In some embodiments, the e-reading device 110 includes features for providing functionality related to displaying paginated content. The e-reading device 110 can include page transitioning logic 115, which enables the user to transition through paginated content. The e-reading device 110 can display pages from e-Books, and enable the user to transition from one page state to another. In particular, an e-Book can provide content that is rendered sequentially in pages, and the e-Book can display page states in the form of single pages, multiple pages or portions thereof. Accordingly, a given page state can coincide with, for example, a single page, or two or more pages displayed at once. The page transitioning logic 115 can operate to enable the user to transition from a given page state to another page state In the specific example embodiment where a given page state coincides with a single page, for instance, each page state corresponding to one page of the digitally constructed series of pages paginated to comprise, in one embodiment, an e-Book. In some implementations, the page transitioning logic 115 enables single page transitions, chapter transitions, or cluster transitions (multiple pages at one time).

The page transitioning logic 115 can be responsive to various kinds of interfaces and actions in order to enable page transitioning. In one implementation, the user can signal a page transition event to transition page states by, for example, interacting with the touch-sensing region of the display 116. For example, the user may swipe the surface of the display 116 in a particular direction (e.g., up, down, left, or right) to indicate a sequential direction of a page transition. In variations, the user can specify different kinds of page transitioning input (e.g., single page turns, multiple page turns, chapter turns, etc.) through different kinds of input. Additionally, the page turn input of the user can be provided with a magnitude to indicate a magnitude (e.g., number of pages) in the transition of the page state.

For example, a user can touch and hold the surface of the display 116 in order to cause a cluster or chapter page state transition, while a tap in the same region can effect a single page state transition (e.g., from one page to the next in sequence). In another example, a user can specify page turns of different kinds or magnitudes through single taps, sequenced taps or patterned taps on the touch sensing region of the display 116. Although discussed in context of “taps” herein, it is contemplated that a gesture action provided in sufficient proximity to touch sensors of display 116, without physically touching thereon, may also register as a “contact” with display 116, to accomplish a similar effect as a tap, and such embodiments are also encompassed by the description herein.

According to some embodiments, the e-reading device 110 includes display sensor logic 135 to detect and interpret user input or user input commands made through interaction with the touch sensors 138. By way of example, display sensor logic 135 can detect a user making contact with the touch-sensing region of the display 116, otherwise known as a touch event. More specifically, display sensor logic 135 can detect a touch events also referred to herein as a tap, an initial tap held in contact with display 116 for longer than some pre-defined threshold duration of time (otherwise known as a “long press” or a “long touch”), multiple taps performed either sequentially or generally simultaneously, swiping gesture actions made through user interaction with the touch sensing region of the display 116, or any combination of these gesture actions.

Although referred to herein as a “touch” or a tap, it should be appreciated that in some design implementations, sufficient proximity to the screen surface, even without actual physical contact, may register a “contact” or a “touch event”. Furthermore, display sensor logic 135 can interpret such interactions in a variety of ways. For example, each such interaction may be interpreted as a particular type of user input associated with a respective input command, execution of which may trigger a change in state of display 116.

The term “sustained touch” is also used herein and refers to a touch event that is held in sustained contact with display 116, during which sustained contact period the user or observer may take additional input actions, including gestures, on display 116 contemporaneously with the sustained contact. Thus a long touch is distinguishable from a sustained touch, in that the former only requires a touch event to be held for some pre-defined threshold duration of time, upon expiration of which an associated input command may be automatically triggered.

In one implementation, display sensor logic 135 implements operations to monitor for the user contacting or superimposing upon, using a finger, thumb or stylus, a surface of display 116 coinciding with a placement of one or more touch sensor components 138, that is, a touch event, and also detects and correlates a particular gesture (e.g., pinching, swiping, tapping, etc.) as a particular type of input or user action. Display sensor logic 135 may also sense directionality of a user gesture action so as to distinguish between, for example, leftward, rightward, upward, downward and diagonal swipes along a surface portion of display 116 for the purpose of associating respective input commands therewith.

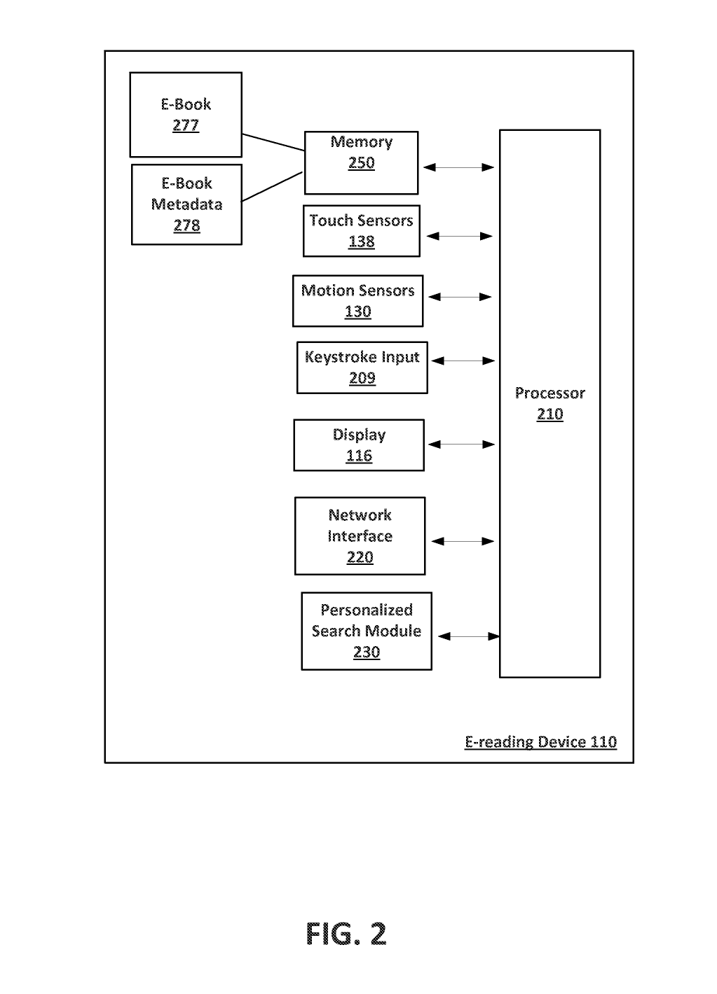

FIG. 2 illustrates further detail of e-reading device 110 as described above with respect to FIG. 1, in an embodiment, e-Reading device 110 further includes processor 210, a memory 250 storing instructions and logic pertaining at least to display sensor logic 135, and page transition logic 115. Stored in memory 250 of e-Reading device 110 are e-Book 277 and the associated e-Book metadata 278. In general, metadata 278 refers to information about the e-book 277 to help sell or catalog it as well as to help potential readers learn what the e-Book is about. One type of metadata is core metadata. Core metadata may include, but is not limited to, publisher information, author information, price, artist information, book title, ISBN, category, copyright information, series information, and the like. Enhanced metadata or market related metadata may also be present. In general, enhanced metadata can include reviews, sample pages, author bios, etc.

Processor 210 can implement functionality using the logic and instructions stored in memory 250. Additionally, in some implementations, processor 210 utilizes the network interface 220 to communicate with the network service 120 (see FIG. 1). More specifically, the e-reading device 110 can access the network service 120 to receive various kinds of resources (e.g., digital content items such as e-Books, configuration files, account information), as well as to provide information (e.g., user account information, service requests etc.). For example, e-reading device 110 can receive application resources, such as e-Books or media files, that the user elects to purchase or otherwise download via the network service 120. The application resources that are downloaded onto the e-reading device 110 can be stored in memory 250.

Display 116 of e-reading device 110 includes touch functionality whereby user input commands may be accomplished via gesture actions performed at display 116. In the context of reading digitally rendered pages comprising content of an e-Book, for example, some common input commands accomplished via gesture actions received at display 116 may include, for example, page turns, making annotations, adjusting illumination levels or contrast of the device display screen, and re-sizing the font size of text in the content.

In some implementations, display 116 can correspond to, for example, a liquid crystal display (LCD) or light emitting diode (LED) display that illuminates in order to provide content generated from processor 210. In some implementations, display 116 can be touch-sensitive. For example, in some embodiments, one or more of the touch sensor components 138 may be integrated with display 116. In other embodiments, the touch sensor components 138 may be provided (e.g., as a layer) above or below display 116 such that individual touch sensor components 138 track different regions of display 116. Further, in some variations, display 116 can correspond to an electronic paper type display, which mimics conventional paper in the manner in which content is displayed. Examples of such display technologies include electrophoretic displays, electro-wetting displays, and electro-fluidic displays.

Processor 210 can optionally receive input from various sources, including touch sensor components 138, display 116, keystroke input 209 such as from a virtual or rendered keyboard, and other input mechanisms (e.g., buttons, mouse, microphone, etc.). With reference to examples described herein, processor 210 can respond to input detected at the touch sensor components 138. In some embodiments, processor 210 responds to inputs from the touch sensor components 138 in order to facilitate or enhance e-Book activities such as generating e-Book content on display 116, performing page transitions of the displayed e-Book content, powering off the e-reading device 110 and/or display 116, activating a screen saver, launching or closing an application, and/or otherwise altering a state of display 116.

In some embodiments, memory 250 may store display sensor logic 135 that monitors for user interactions detected through the touch sensor components 138, and further processes the user interactions as a particular input or type of input. In an alternative embodiment, display sensor logic 135 may be integrated with the touch sensor components 138. For example, the touch sensor components 138 can be provided as a modular component that includes integrated circuits or other hardware logic, and such resources can provide some or all of display sensor logic 135. In variations, some or all of display sensor logic 135 may be implemented with processor 210 (which utilizes instructions stored in memory 250), or with an alternative processing resource.

In one embodiment, network interface 220 of e-reading device 110 includes wireless connectivity subsystems, comprising a wireless communication receiver, a transmitter, and associated components, such as one or more embedded or internal antenna elements, local oscillators, and a processing module such as a digital signal processor (DSP) (not shown). As will be apparent to those skilled in the field of communications, the particular design of the wireless connectivity subsystem of network interface 220 depends on the communication network in which e-reading device 110 is intended to operate, such as in accordance with Wi-Fi, Bluetooth, Near Field Communication (NFC) communication protocols, and the like.

In one embodiment, personalized search module 230 of e-reading device 110, performs an analysis and applies flowchart 300 to determine personalized search results for an e-Book query.

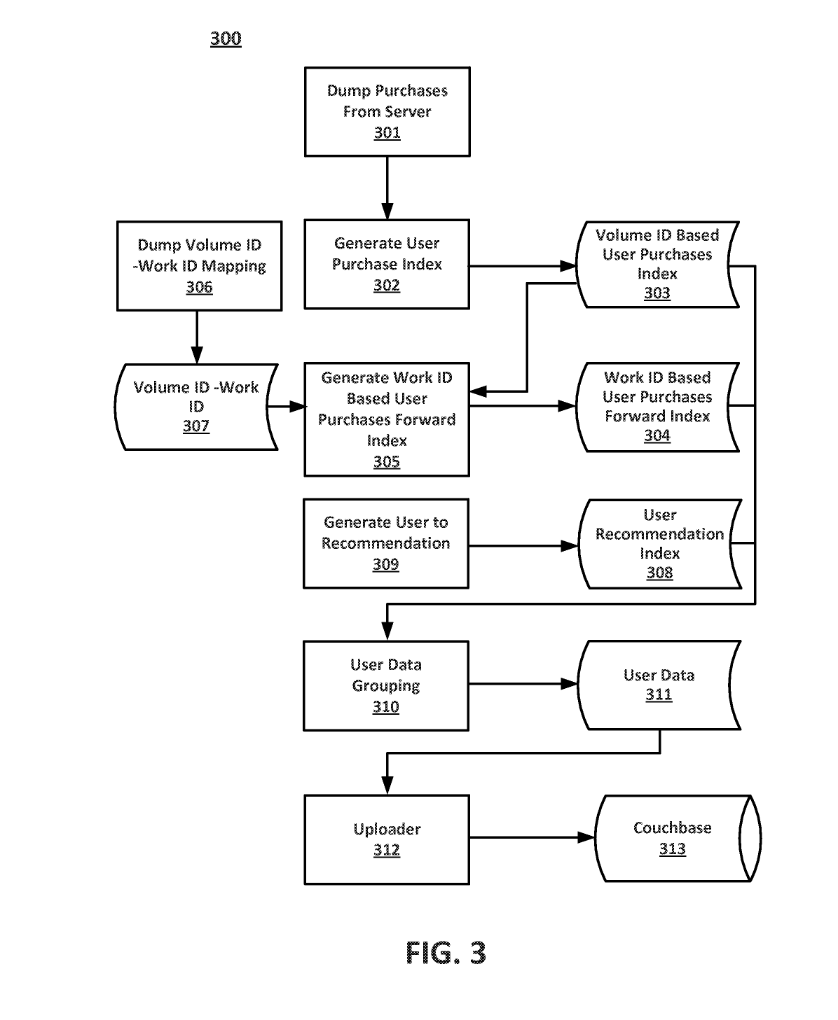

With reference now to FIG. 3 a flowchart 300 for personalizing an e-Book search query is shown, according to an embodiment. For example, personalizing a user's query results is based on information particular to the user him/herself. In one embodiment, in the context of eBook commerce, personalizing a user's search query is expanded to include information such as, but not limited to, taking into account information about which books a user has already purchased, which books they have reviewed, which books they have rated, which books purchased were actually read to completion, which books are likely interesting for them based on a personal recommendation system's output, and the like.

At 301 the purchases from a server are dumped. For example, the information from user account 125 of user account store 124.

A user purchase index 302 is generated from the server dump of 301. The user purchase index information of 302 is sorted into a volume identification based user purchases index 303, a work ID based user purchases forward index 304 and a user recommendations index 308.

Additionally, a dump volume ID to work ID mapping index 306 is also provided.

The volume ID user purchases index 303 information is then provided to generate a work ID based user purchase forward index 305 where the volume ID to work ID mapping 307 is performed on the volume ID based user purchase forward index of 305. In other words, all the volume ID information from the data dump of 301 is transformed into work ID information.

The work ID information derived from the volume ID information at 305 is combined with work ID information from the user purchase index 302 to provide the work ID based user purchases forward index 304.

In addition, user recommendations are generated 309 and provided to user recommendations index 308.

The data from volume identification based user purchases index 303, work ID based user purchases forward index 304 and user recommendations index 308, is then provided to user data grouping 310 which is analyzed by user data 311 to develop personalized information for a specific user. The personalized information is then provided to uploader 312 which stores the resultant personalized information in couchbase 313, a database of personalized information. In one embodiment, the operations described in flowchart 300 may be performed every time a search query is made, may be updated at a specified interval, may be updated as a selected number of book purchases are performed, or the like. Moreover, although flowchart 300 deals with purchases, a similar flowchart may be used to deal with other user information such as, but not limited to, e-Book reviews, author reviews, e-Books read to completion, e-Book ratings, and the like.

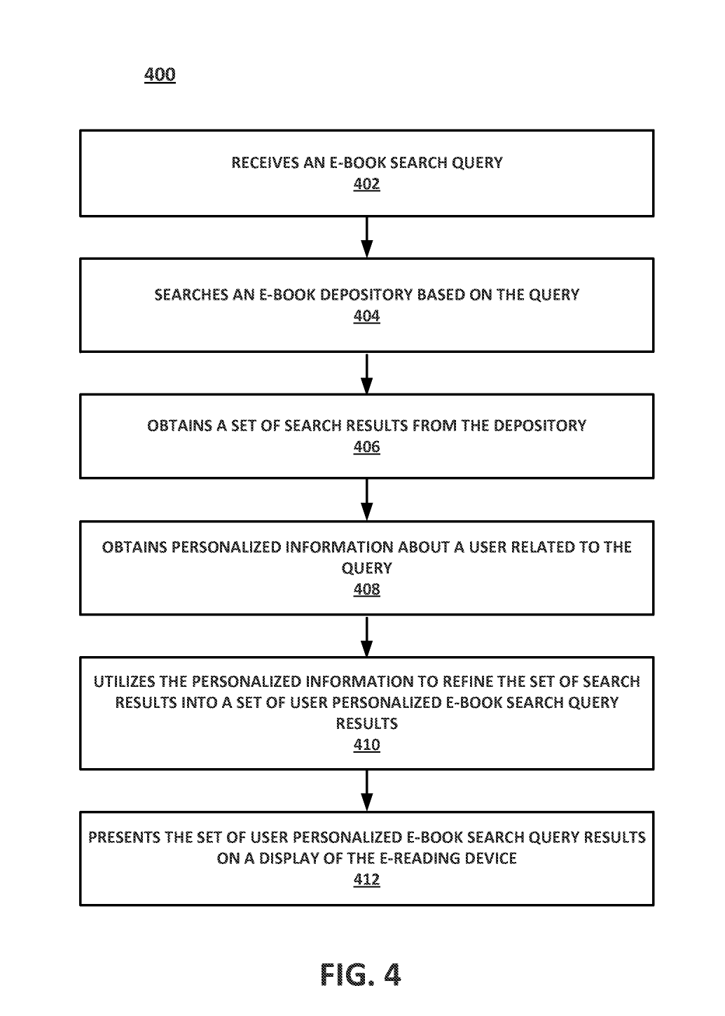

With reference now to FIG. 4, a method for personalizing an e-Book search query is shown in accordance with an embodiment.

Referring now to 402 of FIG. 4 and to FIGS. 1 and 2, one embodiment receives an e-Book search query. In embodiments, the query can be received at a number of locations or devices such as, but not limited to a mobile application, a computing device hosting a website such as the kobo website, an e-reading device 110, or the like.

With reference now to 404 of FIG. 4 and to FIGS. 1 and 2, one embodiment searches an e-Book depository, such as resource store 122, based on the query.

Referring now to 406 of FIG. 4 and to FIG. 2, one embodiment obtains a set of search results from the depository. One embodiment organizes the set of search results according to a relevancy determination. For example, the relevancy determination may utilize one or more rules such as, but not limited to, a popularity of clicking on a particular result, a level of match between the query and the e-Book, how often results are purchased, how often a preview is viewed or downloaded, a popularity of an author, and the like.

With reference now to 408 of FIG. 4 and to FIG. 1, one embodiment obtains personalized information about a user related to the query. In one embodiment, the personalized information is obtained from and account 125 in user account store 124. In one embodiment, the personalized information about the user related to the query is the personalized information of the user performing the e-Book search query. In other words, the user performing the search is the user for whom the search is being performed. For example, Nan wants to find a new book to read. She would be the person asking the search query and she would also be the person for whom the search was intended.

In contrast, in one embodiment, the personalized information about the user related to the query is personalized information of someone other than a user performing the e-Book search query. In other words, the user performing the search is not the same user for whom the search is being performed. For example, Nan wants to find a new book as a gift for her friend Jessica. Nan would be the person asking the search query but the personalized information that would be used would be Jessica's personalized information. E.g., the person for whom the search was intended. In one embodiment, Nan may need Jessica's permission to access Jessica's user store account 125. For example, Jessica may provide Nan with a limited time access to her user store account 125 personalized information.

In one embodiment, the personalized information about the user can include information such as, but not limited to, an e-Book the user has purchased, an e-Book the user has written a review on, an e-Book the user has rated, an e-Book the user has read to completion, an e-Book recommendation provided to the user, and the like. In general, the determining of whether or not the user has purchased the e-Book may be obtained from a volume identification, a work identification, or the like. Moreover, a recommendation may be received from a friend, a personal recommendation system, or the like.

Referring now to 410 of FIG. 4 and to FIG. 3, one embodiment utilizes the personalized information to refine the set of search results into a set of user personalized e-Book search query results.

In another embodiment, the search of the e-book depository may be performed after both the e-Book search query and the personalized information have been received. Thus, instead of receiving a set of search query results that need to be refined based on personalized information, the search results obtained from the depository search would be a set of user personalized e-Book search query results. The set of personalized e-Book search query results could then be sorted based on the relevancy determination.

With reference now to 412 of FIG. 4 and to FIG. 1, one embodiment presents the set of user personalized e-Book search query results on a display of the e-reading device 110.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments.

What is claimed is:

1. A method for personalizing an e-Book search query, the method comprising:
receiving an e-Book search query;
searching an e-Book depository based on the query;
obtaining a set of search results from the depository;
obtaining personalized information about a user related to the query;
utilizing the personalized information to refine the set of search results into a set of user personalized e-Book search query results; and
presenting the set of user personalized e-Book search query results on a display of an e-reading device.

2. The method as recited by claim 1, wherein comprises:
organizing the set of search results according to a relevancy determination.

3. The method as recited by claim 2, wherein the relevancy determination utilizes one or more rules from the group consisting of: a popularity of clicking on a particular result, a level of match between the query and the e-Book, how often results are purchased, how often a preview is viewed or downloaded, and the popularity of an author.

4. The method as recited by claim 1, wherein the personalized information about the user related to the query is the personalized information of a user performing the e-Book search query.

5. The method as recited by claim 1, wherein the personalized information about the user related to the query is personalized information of someone other than a user performing the e-Book search query.

6. The method as recited by claim 1, wherein the personalized information about the user is selected from the group consisting of information about: an e-Book the user has purchased, an e-Book the user has written a review on, an e-Book the user has rated, an e-Book the user has read to completion, and an e-Book recommendation provided to the user.

7. The method as recited by claim 6, further comprising:
determining whether the user has already purchased the e-Book from a volume identification.

8. The method as recited by claim 6, further comprising:
determining whether the user has already purchased the e-Book from a work identification.

9. The method as recited by claim 6, further comprising:
receiving the e-Book recommendation from a personal recommendation system.

10. A computing device comprising:
a memory that stores a set of instructions, an e-Book having digital content therein and metadata associated with the e-Book;
a processor that accesses the instructions in memory, the processor configured to:
receive an e-Book search query;
search a resource store based on said e-Book search query and obtain a set of search results from the search;
access a user account store comprising personalized information about a user related to the query;
utilize the personalized information to refine the set of search results into a set of user personalized e-Book search query results; and
provide the set of user personalized e-Book search query results on a display of an e-reading device.

11. The computing device of claim 10, wherein the search results are organized according to a relevancy determination.

12. The computing device of claim 11, wherein the relevancy determination utilizes one or more rules from the group consisting of: a popularity of clicking on a particular result, a level of match between the query and the e-Book, how often results are purchased, how often a preview is viewed or downloaded, and the popularity of an author.

13. The computing device of claim 10, wherein the personalized information about the user related to the query is the personalized information of a user performing the e-Book search query.

14. The computing device of claim 10, wherein the personalized information about the user related to the query is personalized information of someone other than a user performing the e-Book search query.

15. The computing device of claim 10, wherein the personalized information about the user is selected from the group consisting of information about: an e-Book the user has purchased, an e-Book the user has written a review on, an e-Book the user has rated, an e-Book the user has read to completion, and an e-Book recommendation provided to the user.

16. A non-transitory computer-readable storage medium storing instructions that, when executed by a hardware processor of a computing device, cause the hardware processor to perform a method for personalizing an e-Book search query, the method comprising:
receiving an e-Book search query;
receiving personalized information about a user associated with the query;
searching an e-Book depository based on the query and the personalized information;
obtaining a set of user personalized e-Book search query results from the depository;
sorting the set of user personalized e-Book search query results according to a relevancy determination; and
displaying the sorted set of user personalized e-Book search query results on an e-reading device.

17. The non-transitory computer-readable storage medium as recited by claim 16, wherein the relevancy determination utilizes one or more rules from the group consisting of: a popularity of clicking on a particular result, a level of match between the query and the e-Book, how often results are purchased, how often a preview is viewed or downloaded, and the popularity of an author.

18. The non-transitory computer-readable storage medium as recited by claim 16, wherein the personalized information about the user related to the query is personalized information of someone other than a user performing the e-Book search query.

19. The non-transitory computer-readable storage medium as recited by claim 16, wherein the personalized information about the user is selected from the group consisting of information about: an e-Book the user has purchased, an e-Book the user has written a review on, an e-Book the user has rated, an e-Book the user has read to completion, and an e-Book recommendation provided to the user.

20. The non-transitory computer-readable storage medium as recited by claim 19, further comprising:
determining whether the user has already purchased the e-Book from a volume identification; and
determining whether the user has already purchased the e-Book from a work identification.
